(19) United States
(12) Patent Application Publication
(10) Pub. No.: US 2004/0019896 A1
(43) Pub. Date: Jan. 29, 2004

(54) Method of automatic program installation for computer device

(76) Inventor: Wen-Chu Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/418,084

(22) Filed: Apr. 18, 2003

(30) Foreign Application Priority Data
Jul. 23, 2002 (TW) 91116313

(51) Int. Cl. G06F 13/10; G06F 9/00; G06F 15/177; G06F 1/24

(52) U.S. Cl. 719/321; 719/327; 713/1; 713/2; 713/100

(57) ABSTRACT

A method of automatic program installation for a computer device is disclosed, which detects an optical disk containing driver programs of input/output devices of the computer device and displays a setup menu to allow a computer user to select the desired driver programs. The following steps are then proceeded: determining the operating system of the computer; performing driver program installation execution file of the operating system and reading the contents of an installation bootstrap file; executing the driver program associated with the computer chipset contained in the installation bootstrap file; and sequentially installing the driver programs contained in the installation bootstrap file. During the installation, it is automatically determined if re-booting of the computer is required. If it is, then the computer is re-booted when necessary and the installation process continues thereafter to have the process completely done.

### BACKGROUND OF THE INVENTION

1. Field of the Invention

The present invention relates generally to an installation method of computer programs, and in particular to a method of automatic program installation for a computer device.

2. Description of the Prior Art

Computer devices, such as desktop computers and notebook computers, are the most commonly used office automation equipment, which are often used in letter drafting, documentation, database establishment and search, engineering design, accounting operation, and data communication. Thus, the computer devices are widely used by a variety of persons. However, it is noted that most of the computer users do not have knowledge in installing computer software to enhance the operation efficiency of the computer devices. In addition, some of the computer software that is currently available in the market is not user-friendly enough to enable the general computer users to install the software all by themselves.

FIG. 1 of the attached drawings shows a simplified system block diagram of a computer device, which typically comprises a number of typical computer components, including a central processing unit (CPU) 1, a main memory 2, a bus bridge 3, a Basic Input and Output System Read Only Memory (commonly referred to as BIOS ROM) 4, a hard disk drive 5, a display 6, an optical disk drive 7, and input/output devices 8. The central processing unit 1 is in communication with the main memory 2 via a system bus 11 which is comprised of an address bus, a data bus and a control bus. The system bus 11 is connected to a PCI/ISA bus 12 via the bus bridge 3. The BIOS ROM 4 contains BIOS program 41 and Power On Self Test (POST) program 42. The hard disk drive 5 is coupled to the PCI/ISA bus 12 by a hard disk interface 50, such as an IDE interface. The display 6 is coupled to the PCI/ISA bus 12 by a display interface 60. The optical disk drive 7 is coupled to the PCI/ISA bus 12 by an optical disk interface 70. The input/output devices 8, such as a keyboard, a computer mouse and a joystick, are coupled to the PCI/ISA bus 12 by input/output control interfaces 80.

In installing driver software and/or application programs in the computer according to the prior art, an optical disk stored with specific program is inserted into the optical disk drive and accessed by the computer for retrieving and copying the application programs and/or the drivers onto memory devices of the computer. Conventionally, to start the installation, a SETUP or INSTALLATION file must be found and executed first. Once this is done, the next step of installation process can only proceed. Such a conventional process is quite time-consuming and requires the user to continuously search for the required files. Unfortunately, most of the computer users simply skip certain steps in the standard installation process, which may lead to improper operation of the computer. Thus, most of the computer uses must consult expert for correctly installing computer software.

In addition, for proper functioning of the computer system, upgrading operating system of a computer usually requires upgrade of the driver programs at the same time. Therefore, when the users attempt to upgrade the operating system of their computers, they have to upgrade the driver program also. However, for those lay computer users, it is a tough time to determine the proper version of driver program for a particular version of operating system. Again, the computer users must consult expert in this respect.

To help the general computer users to properly install computer software, some of the software designers and manufacturers provide their software with a user-friendly installation process. Thus, the computer users may readily install the software. An example is shown in U.S. Pat. No. 6,324,690, which teaches an installation technique for application software wherein a host computer in a local area network controls and performs installation of application software into a target computer that is comprised of the local area network. The technique allows a computer system manager to arbitrarily install particular application software to a particular computer of the network without the intervention of the user of the particular computer. Although the technique does help installation of software without the intervention of the true computer user, it is only applicable to a network-based computer architecture, which means a computer must be connected to a network in order to be served with the automatic installation of software. Connection with a network is, however, even harder for a general computer user.

### SUMMARY OF THE INVENTION

Thus, a primary object of the present invention is to provide an automatic program installation method of computer device, which allows a computer user to readily install selected drivers and application programs. The computer users only need to pick up the desired drivers associated with the computer in an installation menu and the method of the present invention automatically proceeding silent installation of the drivers and associated application programs.

Another object of the present invention is to provide an automatic silent program installation method of computer wherein, based on the contents of a bootstrap file, the computer is automatically re-booted as a part of the software installation process and wherein the installation process continues after the re-booting to eventually complete the installation process.

A further object of the present invention is to provide an automatic program installation method of computer wherein a user is allowed to build up a bootstrap file in accordance with peripheral devices of a computer system whereby installation sequence of drivers of the peripheral devices can be automatically executed in a sequence defined in the boot strap file.

To achieve the above objects, in accordance with the present invention, there is provided an automatic program installation method of computer device, which detects an optical disk containing the driver programs of input/output devices of the computer and displays a setup menu to allow a computer user to select the desired input/output devices. The following steps are then proceeded: determining the operating system of the computer; performing driver program installation execution file of the operating system and reading the contents of an installation bootstrap file; executing the driver program associated with the computer chipset contained in the installation bootstrap file; and sequentially installing the driver programs contained in the installation bootstrap file. During the installation, it is automatically determined if re-booting of the computer is required. If it is, then the computer is re-booted when necessary and the installation process continues thereafter to have the process completely done.

### BRIEF DESCRIPTION OF THE DRAWINGS

The present invention will be apparent to those skilled in the art by reading the following description of the best mode for carrying out the invention, with reference to the attached drawings, in which:

FIG. 1 is a simplified system block diagram of a conventional computer system; and

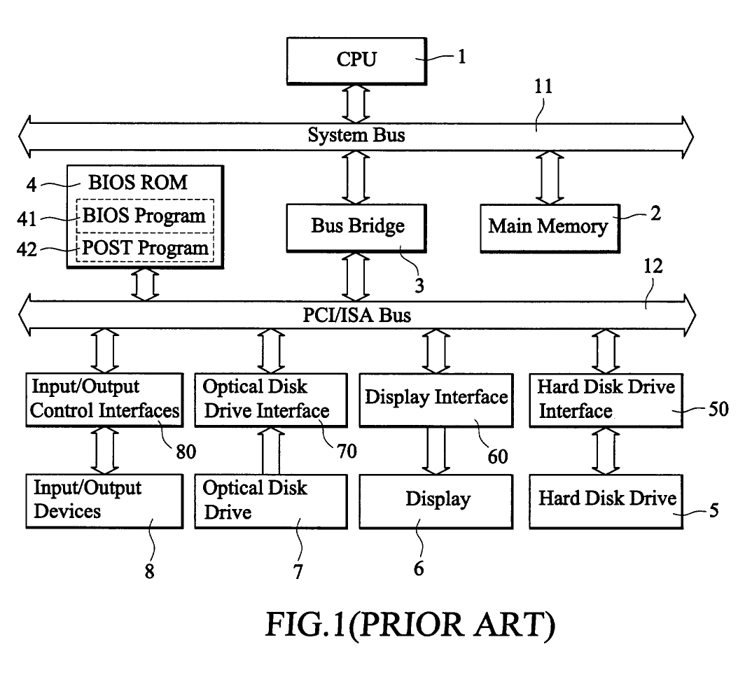

FIG. 2 is a flow chart of an automatic program installation method in accordance with the present invention.

### DETAILED DESCRIPTION OF THE PREFERRED EMBODIMENTS

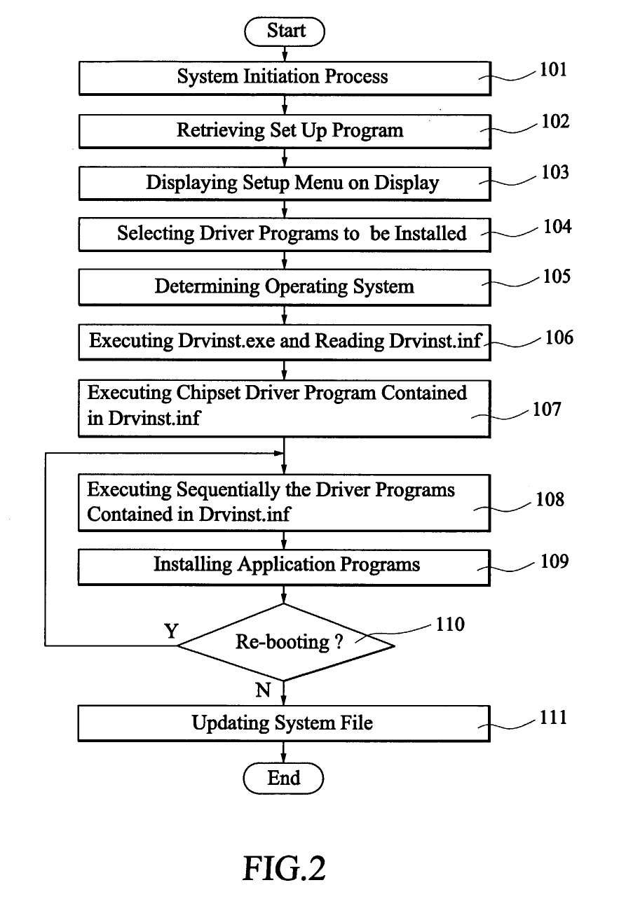

With reference to the drawings and in particular to FIG. 2, an automatic program installation method in accordance with the present invention is shown. When a computer system in which the present invention is embodied is booted up, the computer starts a system initiation process at step 101, which includes system testing, BIOS test, power on self test and loading operating system and other standard processes.

Once the system initiation process 101 is completed, the computer accesses recording media in which driver programs of input/output devices or peripheral devices of the computer are stored for retrieving a setup program at step 102. In the embodiment illustrated, the recording media comprise an optical disk in which all kinds of drivers programs and application programs associated with the input/output devices of the computer are stored.

The optical disk drive of the computer detects the optical disk and reads the setup program whereby a setup menu is shown on a display of the computer, step 103. The setup menu comprises a selection menu allowing the computer user to select the desired drivers in association with the computer system. The user may then use the selection menu to select the driver programs that are to be installed in the computer, step 104.

After the user's selection of the desired driver programs, the computer starts the installation with silent installation process under Windows operating system environments to sequentially install the selected driver programs and the associated application programs. In the silent installation process in accordance with the present invention, the operating system under which the computer is running is detected and determined first at step 105. The currently preferred embodiment of the present invention is implemented for operation in known windows operating system, such as “Windows 98”, “Windows Me”, “Windows 2000” and “Windows XP”, all available from Microsoft Corporation.

If the operating system of the computer is “Windows 98”, then the operating system comprises two execution files, Drvinst.exe (driver program installation execution file) and DrvInst16.exe (16-bit device installation execution file), and a bootstrap file, Drvinst.inf (installation bootstrap file). If the operating system is “Windows Me”, “Windows 2000” or “Windows XP”, then the operating system comprises a driver program installation execution file, Drvinst.exe, and an installation bootstrap file, Drvinst.inf.

Either one of the installation bootstrap file-Drvinst.inf is a user definable file which allows the computer user to define the contents thereof. The bootstrap file-Drvinst.inf comprises a number of execution sequence sections, each comprising a particular driver program associated with a particular input/output device and the associated parameters, such as file location, identification code, waiting time and re-booting required, for distinction of the particular driver program. The file combines the installation processes for all desired input/output devices together in a sequential manner.

The computer then performs the installation execution file, Drvinst.exe, and read in the file contents of the bootstrap file-Drvinst.inf at step 106. The bootstrap file contains chipset driver program associated with the chipset of the computer system, which, together with associated application program, is executed first at step 107.

In step 108, all driver programs defined in the execution sequence sections of the bootstrap file-Drvinst.inf are executed to install the driver programs for all selected input/output devices, such as floppy disk drive, display, sound card, infrared transmission interface, local network, modem, USB, and mouse. In installing the driver programs, if the operating system is “Windows 98”, then the installation execution file-Drvinst.exe performs the installation by means of the execution file-DrvInst16.exe, and if the operating system is “Windows Me”, “Windows 2000” and “Windows XP”, then the execution file Drvinst.exe directly performs the installation.

After step 108, application programs associated with the driver programs are installed, step 109. In accordance with the present invention, it automatically checks if re-booting of the computer is required during the installation of the driver programs and the application programs, step 110. If it is, then the computer is automatically rebooted and the method of the present invention goes back to step 108 for continuing the installation process for other devices. If re-booting of the computer is not required at step 110, the system file of the computer is updated at step 111 to finish the installation process in accordance with the present invention.

To this point, it is apparent that the automatic program installation method in accordance with the present invention allows for automatic and efficient installation of driver programs and application programs of the computer peripheral devices without user's intervention. This helps the computer users in installing the driver programs and also enhances the operation of the computer.

Although the present invention has been described with reference to the best mode of operation thereof, it is apparent to those skilled in the art that a variety of modifications and changes may be made without departing from the scope of the present invention which is intended to be defined by the appended claims.

What is claimed is:

1. An automatic program installation method of installing a plurality of driver programs for a plurality of corresponding input/output devices coupled to a computer device after an initialization process of the computer device under an operating system, the method comprising the following steps:
(a) accessing a recording medium in which the driver programs are stored to retrieve a setup program from the recording medium;
(b) displaying a setup menu associated with the setup programs on a display of the computer device, the setup menu showing a selection menu;
(c) selecting at least one desired driver programs from the selection menu;
(d) executing a driver program installation execution file of the operating system and reading an installation bootstrap file which contains the driver programs, paths and parameters of the associated application programs;
(e) executing a chipset driver program and at least one associated application program contained in the installation bootstrap file; and
(f) sequentially executing the driver programs and the application programs contained in the installation bootstrap file and rebooting the computer if re-booting is required in the installation process, and thereafter continuing the installation process.

2. The automatic program installation method as claimed in claim 1, wherein the recording medium comprises an optical disk in which the driver programs and application programs are stored.

3. The automatic program installation method as claimed in claim 1, wherein the input/output devices of the computer comprise floppy disk drive, display, sound card, infrared transmission interface, local network, modem, USB, and mouse.

4. The automatic program installation method as claimed in claim 1, wherein the operating system is “Windows 98”, which comprises two driver program installation execution files, Drvinst.exe and DrvInst16.exe, and one installation bootstrap file, Drvinst.inf.

5. The automatic program installation method as claimed in claim 4, wherein the installation bootstrap file, Drvinst.inf, comprises a number of execution sequence sections, each comprising driver program and parameters for an input/output device, whereby the driver programs and the application programs of all the input/output devices are all combined together.

6. The automatic program installation method as claimed in claim 5, wherein the installation bootstrap file, Drvinst.inf, is defined by a computer user.

7. The automatic program installation method as claimed in claim 1, wherein the operating system is selected from a group consisting of “Windows ME”, Windows 2000” and “Windows XP”, the operating system comprising one driver program installation execution file, Drvinst.exe, and one installation bootstrap file, Drvinst.inf.

8. The automatic program installation method as claimed in claim 7, wherein the installation bootstrap file, Drvinst.inf, comprises a number of execution sequence sections, each comprising driver program and parameters for an input/output device, whereby the driver programs and the application programs of all the input/output devices are all combined together.

9. The automatic program installation method as claimed in claim 8, wherein the installation bootstrap file, Drvinst.inf, is defined by a computer user.

10. The automatic program installation method as claimed in claim 1, further comprising a step of determining the operating system of the computer before step (d).

11. The automatic program installation method as claimed in claim 1, further comprising a step after step (f) of determining if re-booting the computer is required after the driver programs and application programs are installed.
